(19) United States
(12) Patent Application Publication
(10) Pub. No.: US 2005/0176505 A1
(43) Pub. Date: Aug. 11, 2005

(54) METHOD AND APPARATUS FOR PROVIDING COMPUTER POINTING DEVICE INPUT TO A VIDEO GAME CONSOLE

(76) Inventor: Mark Joseph Stanley, Bellevue, WA (US)

Correspondence Address: MARK STANLEY, 2680 139TH AVE SE #108, BELLEVUE, WA, 98005, US

(21) Appl. No.: 10/774,715

(22) Filed: Feb. 9, 2004

(51) Int. Cl. A63F 13/02

(52) U.S. Cl. 463/37

(57) ABSTRACT

A method and apparatus for adapting a computer pointing device to a video game console. In one embodiment a mouse plugs into an adapter which has an output that plugs into an input of a console. The adapter receives motion data from one or more computer mice and translates this into a format compatible with a game controller for that console. This data is then output to the console which perceives the data as from a single game controller. Thus computer pointing device output, such as from a mouse, is adapted to a console such that the user can control games on that console using the mouse. Data from a computer pointing device can also be combined with data from a keyboard such that the user may play games on a console using a mouse and a keyboard, as is common on personal computers.

### BACKGROUND OF INVENTION

This invention relates to the field of video games, specifically to providing input to a video game console.

There is a class of video games known as “first person shooters”, abbreviated FPS. In these FPS games the video game screen generally shows the view point of a character and generally there is a cross-hair or other type of reticule to show where the character is currently looking and aiming their weapon.

Since approximately the middle 1990's the preferred control mechanism for FPS games played on a personal computer (PC) has been using a mouse and a keyboard. The mouse is used to control the aiming and direction of view, which is usually indicated on screen by a small reticule, and the keyboard keys are used to make the character move forward, backward, left, right, and diagonal throughout 3D world.

Some video game consoles lack any support for a mouse and keyboard and thus the games are generally written to allow the player to only play the game with a standard gamepad type controller. These gamepad controllers are gripped with both hands and have two small joysticks mounted on the top side which are operated by the user's thumbs. These joysticks are typically referred to as “thumbsticks”. There are also several buttons located on various other locations of these gamepad type controllers.

When playing an FPS game with a gamepad controller usually one of the thumbsticks is used for controlling the windage and elevation of the in-game character's reticule, and therefore it controls the direction of view and aiming of the in-game character. The other thumbstick controls the character's movement throughout the 3D world in the forward, backward, left, right, and diagonal directions.

Currently, on certain video game consoles there are many FPS games available but there is no way to play them with a mouse and a keyboard. The only available control mechanism for these games on a video game console is generally the standard gamepad type controller.

A problem with the standard gamepad type controller that comes with most video game consoles is that the aiming and movement are controlled with the user's thumbs using the thumbsticks. These thumbsticks usually are internally composed of two potentiometers: one to measure the X-axis motion of the thumbstick and one to measure the Y-axis motion of the thumbstick. Using these thumbsticks adversely affects aiming and movement precision in several ways. One is that controlling a thumbstick with a single thumb lacks the opposing forces granted by the use of multiple fingers applied to a single input mechanism. Another disadvantage of the dual axis configuration (one potentiometer for the X-axis of motion and a second potentiometer for the Y-axis of motion) of most, if not all, current gamepad thumbstick devices is that there is an inherent motion bias due to friction along these axes. A controller that would offer equal freedom of movement in any given direction would provide a more fluid, intuitive, and accurate input means.

Another disadvantage of using a gamepad to play video games is that a lot of people simply prefer using a mouse and keyboard perhaps for no other reason than they have played using that method on a personal computer for years, have grown accustomed to that input method, and are therefore usually more skillful using that input method.

Furthermore the gamepad input method is unsatisfactory to many game players because one has to have two thumbs on the thumbsticks controlling the direction of view and movement, and the remaining fingers wrapped around the underside of the controller to grip it. This leaves no available fingers to push the buttons on the top side of the controller. This is especially problematic in FPS games because there are many important functions that are assigned to these top buttons that are needed while one's thumbs are busy aiming and moving. This leaves the gamepad user no other choice but to remove a thumb from a thumbstick to press a button when needed. This causes the user's in-game character to momentarily stop moving or aiming, thereby leaving the player's character more vulnerable to the hazards in the video game, such as enemies in the video game firing their weapons at the user's character.

Even if a way to use a mouse and keyboard for such consoles were to be made available, the games that were written prior to the availability of the mouse and keyboard on that system would not be compatible with the mouse and keyboard because those games were likely written to work exclusively with the standard gamepad type controller. It would also be likely that even some games made after the availability of a mouse and keyboard input mechanism on that video game console would still continue to be written to only be compatible with the standard gamepad type video game controller. Therefore a game player that would like to play those games with a mouse and keyboard has no possibility of doing so.

### SUMMARY OF INVENTION

The present invention therefore is generally directed to an adapter that makes it possible for a user to control a video game on a video game console using a mouse and a keyboard to control the direction of view and movement respectively throughout the 3D game environment, as is common on personal computers.

Several objects and advantages of the present invention include, but are not limited to:
(a) to give all players the option to play any video games on a video game console with a mouse, which is a much more accurate means of input than a thumbstick;
(b) to allow players to play FPS games on their video game console using a mouse and a keyboard;
(c) to allow players to control video games on a video game console with other computer pointing devices;
(d) to allow players to control video games with two mice or other computer pointing devices, thereby allowing for smooth input for two aspects of motion within a game, such as direction of view as well as lateral, fore, aft, and diagonal movement;
(e) to allow players to control more functions simultaneously than possible using a gamepad type controller.

In one embodiment of the present invention an adapter plugs into a video game console. The adapter has two standard PS/2 sockets (also known as “6 pin Mini DIN” sockets) which allow for the connection of a PS/2 mouse and a PS/2 keyboard. The adapter has a microprocessor which receives signals from the mouse and keyboard, processes the information from these devices, and outputs signals to the video game console that are in the format of a standard gamepad type controller for that video game console. Before outputting the signals to the video game console the information from the mouse and keyboard is also processed in accordance with user defined settings and mappings. For instance, a user may decide that the left mouse button should produce the same effect as would pressing the A button of the standard controller for that video game console. This and other user defined information is stored in a non-volatile memory such that it will be stored even after the device is unplugged and without power. These settings can be configured by using special keyboard sequences.

In another embodiment of the present invention the adapter body is outfitted with a third PS/2 port to which can be attached a second mouse. With two mice attached, one of the mice can be used to control the aiming and view point, and the other mouse can be used to control the character movement. The buttons on both mice can be used to initiate various functions that would otherwise be performed by the standard gamepad controller. One of the advantages of adding the second mouse to take over the functions of the keyboard is that input that can be provided to a video game via a mouse is far less granular and therefore much smoother and more precise than the movement that can be provided by a keyboard.

Note that the invention is not limited to the aforementioned embodiments, but rather these are examples meant to help crystallize the invention in the mind of the reader. For example, other user interface devices such as trackballs, joysticks, and light pens, etc., can be attached. Any of these devices can be attached to the adapter by a wide variety of physical and wireless means. Furthermore the device itself can be connected to the console via many physical and wireless means as well.

Another very novel aspect of this invention is the manner in which computer pointing device motion information (such as motion in the X-Y plane reported by a computer mouse) is mapped to the thumbstick position of a standard gamepad controller for the target console. There are several ways to map this motion information, but the method that produces results most similar to the mouse motion found on most personal computer FPS games is a mapping that computes the velocity of the mouse and maps this velocity to an X-Y gamepad thumbstick position. Thus if the mouse is moved to a higher velocity, then the adapter of the present invention will report that the user has pushed the gamepad thumbstick further. This is because in most FPS games that utilize a gamepad type controller the further you displace the thumbstick, the faster the movement of the in-game character will be. So using this mapping, the faster the mouse is moved then the faster the in-game character motion will be.

### BRIEF DESCRIPTION OF DRAWINGS

FIG. 1 is a perspective view of a preferred embodiment of the invention.

FIG. 2 is a block diagram showing important elements and signal flow for a preferred embodiment of the invention.

FIG. 3 is a top view of an Xbox (trademark of Microsoft Corporation) gamepad type video game controller.

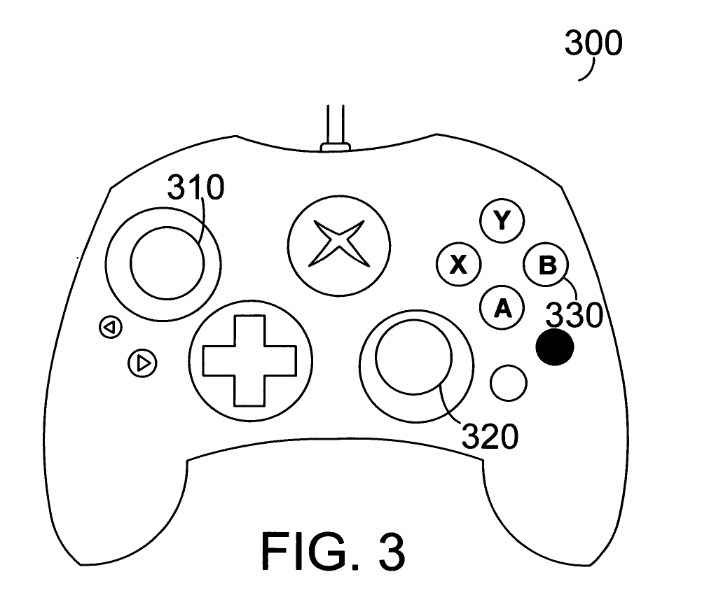

FIG. 4 is a drawing of a printed circuit board of a working prototype of a preferred embodiment of the invention showing necessary components and circuitry.

FIG. 5 is a schematic showing the components and component interconnections of FIG. 4.

### DETAILED DESCRIPTION

The present invention is related t the adaptation of one or more computer pointing devices and a keyboard to be presented to a video game console as a single standard gamepad controller for the purpose of controlling a video game on the video game console. Strictly for the purpose of illustration, an example of a device which plugs into a controller port of a video game console, and which has three PS/2 ports for attaching two computer mice and a keyboard will be discussed herein below, without in anyway intending to limit the invention as set forth in the appended claims.

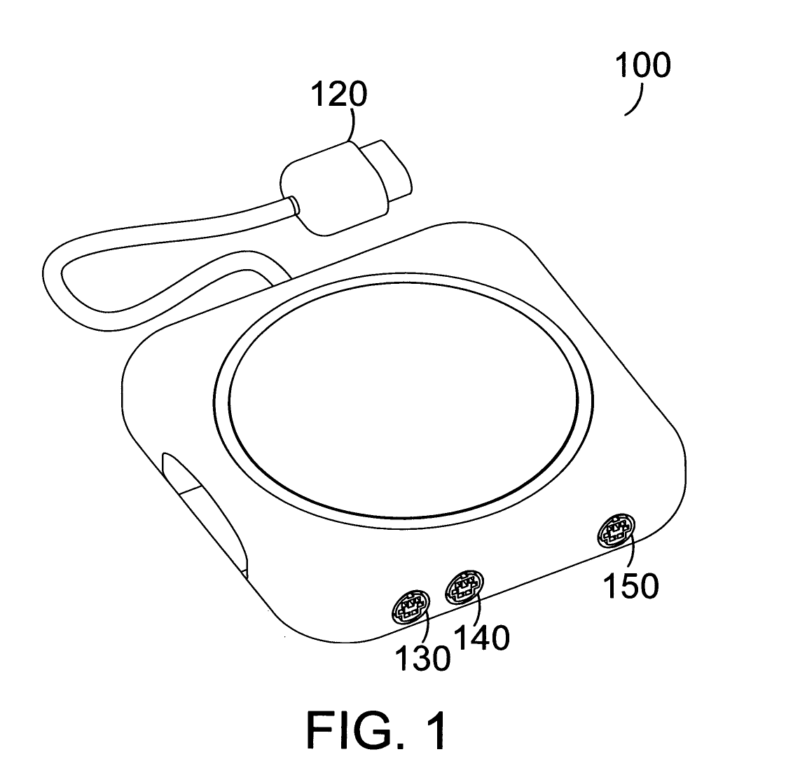

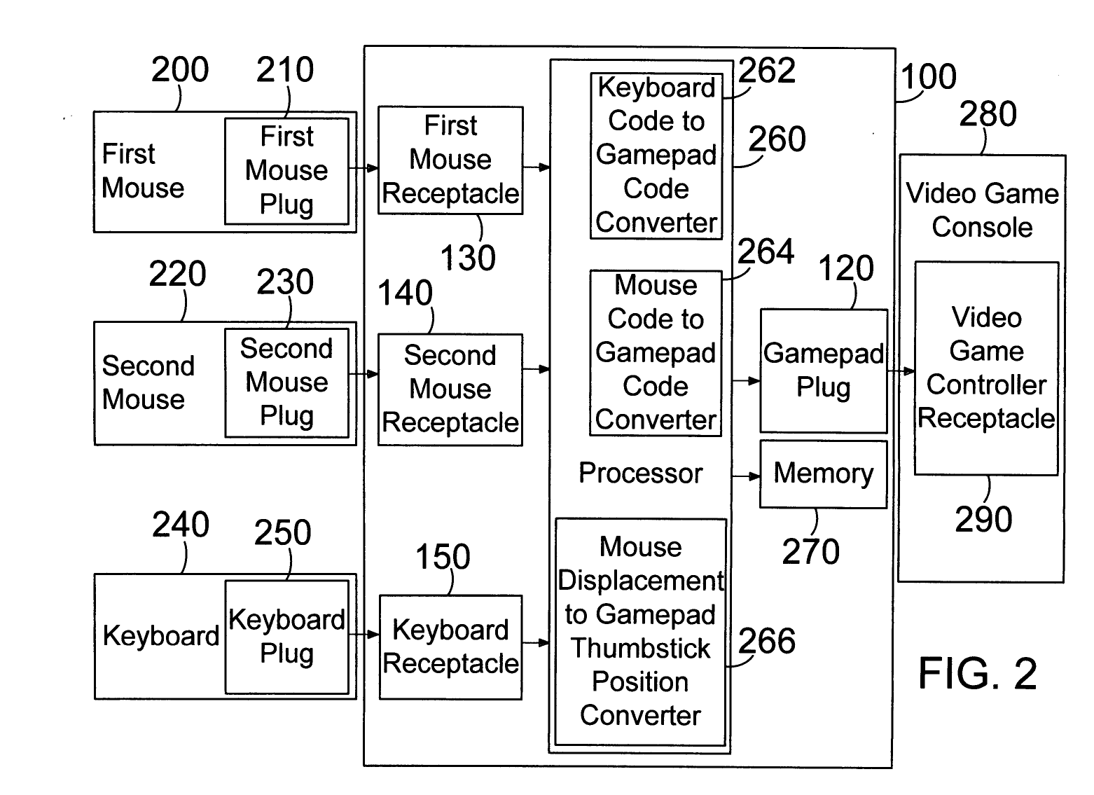

The apparatus 100 in FIG. 1 currently exists as a fully functioning prototype. Referring to FIGS. 1 and 2, an apparatus 100 includes three female PS/2 connectors 130, 140, 150. These connectors are also known as also known as “6 pin Mini DIN” connectors and are the standard socket for plugging in PS/2 devices such as mice, trackballs, and keyboards, etc. Many different types of PS/2 devices can be plugged into the apparatus 100. The mouse receptacle 130 accepts a first mouse plug 210 on a first mouse 200. The apparatus 100 also has a second mouse receptacle 140 which accepts a second mouse plug 230 on a second mouse 220. The apparatus 100 also has a keyboard receptacle 150 which accepts a keyboard plug 250 from a keyboard 240. The first mouse receptacle 130 and second mouse receptacle 140 and keyboard receptacle 150 are connected to a processor 260 which contains a keyboard code to gamepad code converter 262 and a mouse code to gamepad code converter 264 and a mouse displacement to gamepad thumbstick position converter 266. The processor is connected to a memory 270 and a gamepad plug 120. The gamepad plug 120 is plugged into a video game controller receptacle 290 of a video game console 280. In this embodiment the video game console plug 120 is for plugging into an Xbox (trademark of Microsoft Corporation) video game console, but this can just as easily be fitted with other physical or wireless communications means for this and other video game consoles.

The flow of information between the two mice 200, 220 and the video game console 280 is shown in FIG. 2. The mice 200, 220 in this apparatus 100 are know as PS/2 mice because they have a PS/2 style plug and adhere to the PS/2 mouse protocol, the specifics of which are well known. Using its most basic mode a PS/2 mouse generally transmits a three byte packet periodically when it is being moved by the user. The first byte of the three byte packet is a bit mask that relays which mouse button or buttons are pressed at the time the packet was generated. The second byte is the distance along the X-axis that the mouse has moved since the last packet was sent from the mouse. The third byte is the distance along the Y-axis that the mouse has moved since the last packet was sent from the mouse.

Packets of this format are sent from the mice 200, 220 to the processor 260 via the mouse plugs 210, 230 and the mouse receptacles 130, 140. The processor 260 uses the mouse code to gamepad code converter 264 to convert the X-axis and Y-axis movement information and button press information from the mouse into gamepad codes that the video game console 280 can understand. The mouse code to gamepad code converter 264 uses the mouse displacement to gamepad thumbstick position converter 266 to translate the X-axis and Y-axis movement information from the mouse packets into a corresponding X-axis and Y-axis position of a thumbstick 310, 320 on a gamepad type controller 300.

Before describing how the mouse displacement to gamepad thumbstick position converter 266 does this, it is important to note at this point that most FPS games that are implemented on a video game console (as opposed to a personal computer) have the velocity of movement of the reticule (and thus the direction of the in-game character's view and weapon aiming) proportionate to how far the user has displaced a gamepad thumbstick 310, 320. As an example, if a user has a thumbstick pushed 3 millimeters to the right this will cause the in-game character to rotate at a constant velocity clockwise. If the user further pushes the thumbstick such that the thumbstick is now displaced 6 millimeters to the right, then the in-game character rotation velocity will now have approximately doubled (though the mapping is not necessarily linear). And likewise, continuing to hold the thumbstick steady at this displacement will hold the character rotation velocity constant at this level.

A standard computer pointing device, such as a computer mouse, will report how many units it has been displaced by the user since the last time it has reported its displacement. One aspect of the present invention is that it will compute the velocity of the mouse and then map that to a thumbstick position. The mouse displacement to gamepad thumbstick position converter 266 computes the instantaneous velocity of the mouse along its X-axis and the instantaneous velocity of the mouse along its Y-axis. Since velocity is distance per unit time, the mouse displacement to gamepad thumbstick position converter 266 calculates the velocity by using the X-axis and Y-axis movement information from the m use packets and the time since the last packet was received.

Since in most console FPS games the speed of the in-game character is determined by the offset of a thumbstick, for example the right thumbstick 320, the mouse displacement to gamepad thumbstick position converter 266 then scales the calculated mouse velocity into the range of values supported by the gamepad thumbstick 320 and reports this as the thumbstick position. The calculated velocity of the mouse, aside from some further ancillary processing, is reported to the video game console as an indication of how far the user has pushed the gamepad thumbstick 320. The mouse code to gamepad code converter 264 will then take this value and translate it into gamepad codes which are output to the video game console 280 via the gamepad plug 120 which is connected to the video game controller receptacle 290. In this way the computer pointing device is mapped to a gamepad controller 300 for that video game console. The instantaneous velocity of the mouse is continuously calculated and reported to the video game console as proportionate to thumbstick displacement as described and the resulting user interaction of the mouse and its effect on the in-game character movement very closely approximates that which is found on personal computer FPS games. That is, when the user moves the mouse around then the in-game character's direction of view will move fluidly in concert with the user's mouse movement direction and speed. This is of course one of the main goals of the present invention, and is reduced to practice currently in prototype form and functioning as described.

The mouse code to gamepad code converter 264 can optionally do additional processing on the value returned from the mouse displacement to gamepad thumbstick position converter 266. For instance, in the current prototype the user can configure the mouse as “inverted”. The mouse code to gamepad code converter 264 fetches this user preference setting from the EEPROM memory 270 and if it indicates an inverted mouse configuration then the Y-axis value returned from the mouse displacement to gamepad thumbstick position converter 266 will be inverted before being converted to a gamepad code. The effect is that when the user pushes the mouse forward the in-game characters direction of view moves downward, instead of upward as in non-inverted operation.

So whereas the aforementioned mapping by the mouse displacement to gamepad thumbstick position converter 266 maps mouse displacement to a gamepad thumbstick position by calculating the mouse velocity, there are other modes of computer pointing device mapping that this embodiment supports as selectable by the user. One such mode is to keep a running count of the displacement of the mouse in a particular direction. This value, subject to adjustment (via a scalar for instance), is reported as the displacement of a gamepad thumbstick 310, 320. This value will continue to be reported to the video game console 280 as the thumbstick displacement even if the user ceases to move the mouse. When the user moves the mouse in an opposite direction then this mouse displacement subtracts from said running count and the thumbstick displacement reported to the video game console is reduced. This mode might be more useful for non-FPS games, such as racing games. A special user key or button press can be used to return the thumbstick displacement value being reported to the video game console to zero. This makes the vehicle in a racing game return to a straight-ahead bearing. Currently this mouse motion mapping mode is user selectable via the special keystroke CTRL-J. This, and other user preferences, are stored in an EEPROM memory chip 270 which holds settings for up to 26 different game profiles. The user can easily select any profile by typing CTRL-P and then a letter from the set ‘A’ through ‘Z’. This allows the user to easily recall previously configured settings for many different games.

As previously mentioned, the first byte of the three byte PS/2 mouse packet is a bit mask that relays which mouse button or buttons are pressed at the time the packet was generated. The processor 260 uses the mouse code to gamepad code converter 264 to convert this mouse button press information into gamepad codes that the video game console 280 can understand. The mouse code to gamepad code converter 264 uses the EEPROM memory 270 to discover which gamepad codes the user has mapped to which mouse buttons. These gamepad codes are output to the video game console 280 via the gamepad plug 120 which is connected to the video game controller receptacle 290.

As mentioned previously this embodiment also supports the attachment of a PS/2 keyboard 240. The PS/2 keyboard 240 outputs bytes to its keyboard plug 250 when user activity occurs. The flow of information between the keyboard 240 and video game console 280 is shown in FIG. 2. The keyboard 240 which plugs into in this embodiment is known as a PS/2 keyboard because it has a PS/2 style plug and it adheres to the PS/2 keyboard protocol, the specifics of which are well known. According to the PS/2 keyboard protocol, for each key the user presses on the PS/2 keyboard a unique single or multi-byte code is sent which corresponds to that particular key; this is called the “make code”. A different (but usually similar) code is sent from the keyboard when the same key is released; this is called the “break code”.

These codes are output from the keyboard 240 to the processor 260 via the keyboard plug 250 and 150 keyboard receptacle. The processor 260 gives a keyboard code to the keyboard code to gamepad code converter 262 which maps the keyboard code to a gamepad code using user settings stored in the EEPROM memory 270. These gamepad codes are output to the video game console 280 via the gamepad plug 120 which is connected to the video game controller receptacle 290. The keyboard codes can be mapped to any of the capabilities supported by the standard gamepad controller 300. For example a particular keyboard code could be mapped to the “B” button 330 of the gamepad controller 300. The code corresponding to this “B” button 330 is then reported to the video game console 280 and activity in the video game will result just as if a standard gamepad controller 300 were attached to the video game console 280 and its “B” button 330 were pressed. Normally in First Person Shooter games on a personal computer a mouse is used by one hand to control the weapon aim and view direction of the in-game character, and a keyboard is used by the player's other hand to control the forward, backward, left, and right movement of the character to propel the character in and around the 3D environment. So as can be seen, the embodiment described herein achieves the goal of adapting the personal computer FPS control methodology to a video game console.

A second mouse 220 can also be attached to the apparatus 100 of FIG. 1. Any of its buttons can be mapped to any of the standard gamepad capabilities. In addition to this, the motion of the mouse 200 is processed and reported to the video game console 280 as the motion of a thumbstick 310, 320 of the standard gamepad controller. The advantage of using this second mouse 220 for the in-game character's forward, backward, left, right, and diagonal movement instead of the keyboard is that a keyboard is only capable of jerky on-off in-game character motion since its keys only have two states: pressed and released. So whereas the first mouse 200 is used to control aiming smoothly, the second mouse 220 is used to control character movement in and around the 3D environment in a smooth manner. This “Dual Mouse Mode” has the advantage of even more precise control than a mouse and keyboard paradigm.

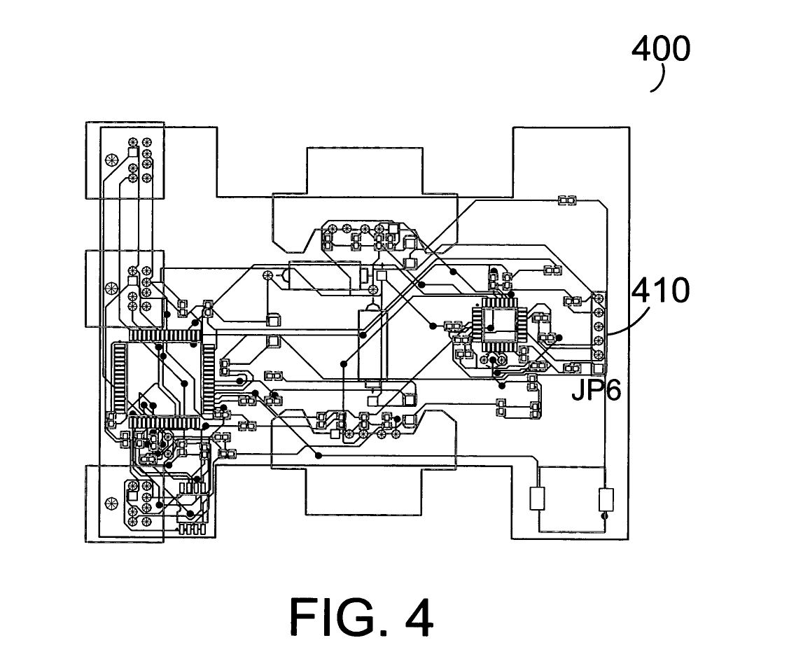

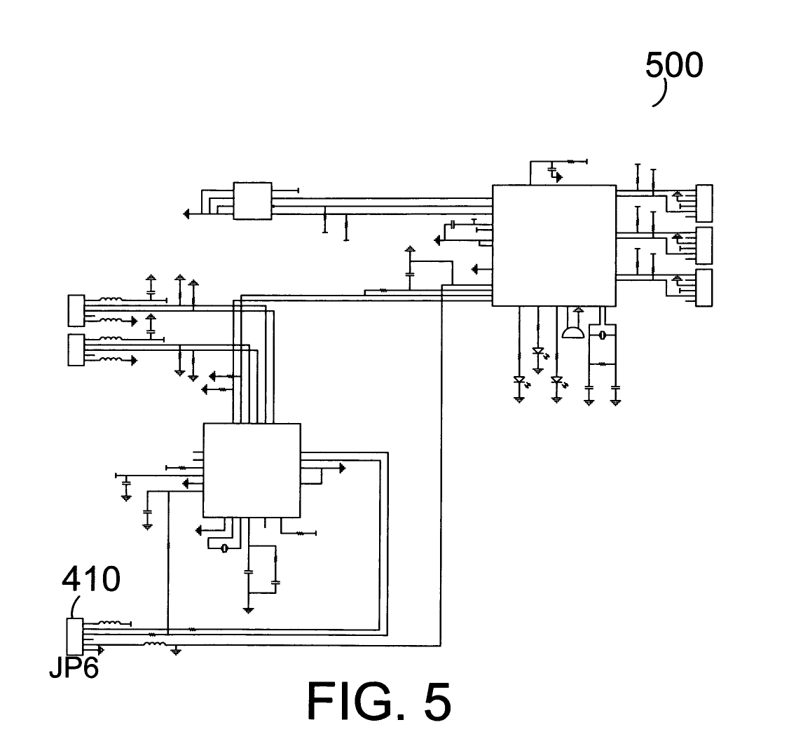

In order to construct the present invention the program listing Program.txt (incorporated by reference as part of the disclosure herein) must be loaded onto the processor 260, which in this case is STMicroelectronics Inc. part number ST92T163R4T1. Program.txt is should be renamed to Program.hex and then is loaded onto an ST92T163R4T1 processor using STMicroelectronics Inc. “ST Visual Programmer version 1.9.5.0” software and an STMicroelectronics Inc. ST92E16X-EPBJ chip programmer. Referring to FIGS. 4 and 5 the schematic 500 shows the specific parts and interconnections of the PCB (“Printed Circuit Board”) diagram 400. Using the schematic 500 and PCB diagram 400 a PCB which includes the ST92T163R4T1 with the Program.hex code encoded onto it can be constructed. The final step is to attach an Xbox (trademark of Microsoft Corporation) gamepad plug 120 to connection JP6 410 which can be seen in PCB diagram 400 of FIG. 4.

Aside from the preferred embodiment presented herein there are numerous other embodiments encompassed by the appended claims. For example in place of computer mice other computer pointing devices can be interfaced such as trackballs, touchpads, tablets, joysticks, light pens, etc., and any combination thereof. Besides PS/2 connections these computer pointing devices can be interfaced with USB, FireWire, Bluetooth, 802.11, or any other wired or wireless means. Also, instead of an adapter, the claims encompass an embodiment where the computer pointing devices such as mice are integrated as a unit, and thus sold as a single product. Furthermore, the means of interfacing the invention described by the claims herein to a video game console could also be via USB, FireWire, Bluetooth, 802.11, or any other wired or wireless means. The invention described by the claims herein could also interfaced with a personal computer instead of a video game console, and also can be used to control any game, not just FPS games. The invention described by the claims herein could also be included in the housing of a mouse or some other computer pointing device or keyboard.

Thus, while there have been shown and described features of the present invention as applied to the preferred embodiments thereof, it will be understood that various omissions and substitutions and changes in the form and details of the devices illustrated, and in their operation, and in the method illustrated and described, may be made by those skilled in the art without departing from the spirit of the invention as broadly disclosed herein. Thus the scope of the invention should be determined by the appended claims and their legal equivalents, rather than by the examples given.

Program Listing Deposit

Program.txt includes 390 lines of code representing an implementation of

1. An apparatus comprising: a receptacle for receiving a plug on a computer mouse; a video game controller plug for plugging into a video game controller receptacle on a video game console; and a computer mouse code to gamepad code converter that converts computer mouse codes received from said computer mouse to gamepad codes that are output to said gamepad plug.

2. The apparatus of claim 1 further comprising: a receptacle for receiving a plug on a computer keyboard; and a computer keyboard code to gamepad code converter that converts computer keyboard codes received from a computer keyboard to gamepad codes that are output to said gamepad plug.

3. The apparatus of claim 1 further comprising: a mouse displacement to gamepad thumbstick position converter that uses the vertical and horizontal displacement information received from a computer mouse to calculate the velocity and direction of said computer mouse and maps said velocity to a vertical and horizontal thumbstick position of a thumbstick on a gamepad style video game controller.

4. The apparatus of claim 3 further comprising: a receptacle for receiving a plug on a computer keyboard; and a computer keyboard code to gamepad code converter that converts computer keyboard codes received from a computer keyboard to gamepad codes that are output to said gamepad plug.

5. The apparatus of claim 1 wherein said computer mouse code to gamepad code converter converts computer mouse codes from a second computer mouse to gamepad codes that are output to said gamepad plug, and further comprising a second receptacle for receiving a plug on computer mouse.

6. The apparatus of claim 5 further comprising: a receptacle for receiving a plug on a computer keyboard; and a computer keyboard code to gamepad code converter that converts computer keyboard codes received from a computer keyboard to gamepad codes that are output to said gamepad plug.

7. The apparatus of claim 5 further comprising: a mouse displacement to gamepad thumbstick position converter that uses the vertical and horizontal displacment information received from said computer mouse to calculate the velocity and direction of said computer mouse and maps said velocity to a vertical and horizontal thumbstick position of a thumbstick on a gamepad style video game controller.

8. An apparatus comprising: a means for receiving signals from a computer pointing device; a means for transmitting signals to a video game console; and a computer pointing device code to video game controller code converter that converts computer pointing device codes received from a computer pointing device to video game controller codes that are transmitted to a video game controller input of a video game console.

9. The apparatus of claim 8 further comprising: a means for receiving signals from a computer keyboard; and a computer keyboard code to video game controller code converter that converts codes received from a computer keyboard to video game controller codes that are transmitted to a video game controller input of a video game console.

10. The apparatus of claim 8 further comprising: a computer pointing device displacement to video game controller thumbstick position converter that uses the vertical and horizontal displacement information received from a computer pointing device to calculate the velocity and direction of said computer pointing device and maps said velocity to a vertical and horizontal thumbstick position of a thumbstick on a video game controller.

11. The apparatus of claim 10 further comprising: a means for receiving signals from a computer keyboard; and a computer keyboard code to video game controller code converter that converts codes received from a computer keyboard to video game controller codes that are transmitted to a video game controller input of a video game console.

12. The apparatus of claim 8 wherein said computer pointing device code to video game controller code converter also converts computer pointing device codes from a second computer pointing device t video game controller codes that are output to said means for transmitting signals to a video game console, and further comprising a means for receiving signals from said second computer pointing device.

13. The apparatus of claim 12 further comprising: a means for receiving signals from a computer keyboard; and a computer keyboard code to video game controller code converter that converts computer keyboard codes received from a computer keyboard to video game controller codes that are transmitted to said video game controller input of a video game console.

14. The apparatus of claim 12 further comprising: a computer pointing device displacement to video game controller thumbstick position converter that uses the vertical and horizontal displacement information received from a computer pointing device to calculate the velocity and direction of said computer pointing device and maps said velocity to a vertical and horizontal thumbstick position of a thumbstick on a video game controller.

15. A method for adapting output from a computer pointing device to a video game console, the method comprising the steps of: determining when a user initiates an action on a computer pointing device; determining which video game controller code corresponds to a computer pointing device code; and mapping computer pointing device codes from said computer pointing device to a corresponding video game controller code of a video game controller; transmitting said corresponding video game controller code to said video game console; whereby codes generated by said computer pointing device are adapted to said video game console such that a user will be able to control a video game existing on said video game console by manipulating said computer pointing device.

16. The method of claim 15 further comprising the step of: mapping computer pointing device codes from a second computer pointing device to video game controller codes of said video game controller.

17. The method of claim 16 wherein said computer pointing device and said second computer pointing device are selected from the group consisting of computer mice and trackballs and touchpads and joysticks and light pens; and wherein said computer pointing device and said second computer pointing device are compatible with a personal computer.

18. The method of claim 16 further comprising the step of: mapping computer keyboard codes from a computer keyboard to video game controller codes of said video game controller.

19. The method of claim 15 further comprising the step of: mapping computer keyboard codes from a computer keyboard to video game controller codes of said video game controller.

20. The method of claim 15 further comprising the step of: computing the velocity and direction of said computer pointing device and mapping said velocity to a vertical and horizontal thumbstick position of a thumbstick of said video game controller.

21. The method of claim 20 wherein said computer pointing device is selected from the group consisting of computer mice and trackballs and touchpads and joysticks and light pens; and wherein said computer pointing device is compatible with a personal computer.

22. The method of claim 15 further comprising the steps of: keeping a running count of the displacement of a computer pointing device along the X-axis of said computer pointing device; keeping a running count of the displacement of said computer pointing device along the Y-axis of said computer pointing device; adding X-axis displacement of said computer pointing device to said running count if said computer pointing device to its right; adding Y-axis displacement of said computer pointing device to said running count if said computer pointing device moved to its forward direction; subtracting X-axis displacement of said computer pointing device from said running count if said computer pointing device is moved to its left; subtracting Y-axis displacement of said computer pointing device from said running count if said computer pointing device is moved to its rearward direction; mapping said X-axis running count to the X-axis value of a gampad thumbstick of a gamepad type video game controller; and mapping said Y-axis running count to the Y-axis value of a gampad thumbstick of a gamepad type video game controller.

23. A method for providing computer pointing device input to a video game, the method comprising the steps of: using the motion data from a computer pointing device selected from the group consisting of computer mice and trackballs and touchpads and joysticks and light pens to control the direction of sight within a three dimmensional computer graphics environment; and using the motion data from a second computer pointing device compatible with a personal computer selected from the group consisting of computer mice and trackballs and touchpads and joysticks and light pens to control the movement of the game character through a three dimensional computer graphics environment; and wherein said computer pointing device and said second computer pointing device are compatible with a personal computer.

24. The method of claim 23 further comprising the step of: processing said motion data from said computer pointing device and said second computer pointing device and producing output data such that the video game perceives the data as coming from a single gamepad style video game controller.

25. The method of claim 24 further comprising the step of: computing the velocity and direction of a computer pointing device and mapping said velocity to a vertical and horizontal thumbstick position of a thumbstick of said gamepad style video game controller.
